(19) United States
(12) Patent Application Publication
(10) Pub. No.: US 2009/0067473 A1
(43) Pub. Date: Mar. 12, 2009

(54) Device for measuring the termperature in a solid phase polycondensation

(76) Inventors: Rainer Hinkelmann, Maintal (DE); Ludwig Holting, Bruchkobel (DE); Michael Kress, Alzenau (DE); Michael Troger, Hanau (DE)

Correspondence Address: K.F. ROSS P.C., 5683 RIVERDALE AVENUE, SUITE 203 BOX 900, BRONX, NY, 10471-0900, US

(21) Appl. No.: 11/918,813

(22) PCT Filed: Feb. 27, 2006
(86) PCT No.: PCT/EP2006/001771

§ 371 Date: Apr. 18, 2008

(30) Foreign Application Priority Data
Apr. 19, 2005 (DE) 10 2005 017 968.1

(51) Int. Cl. G01K 1/08

(52) U.S. Cl. 374/141; 374/E01.011

(57) ABSTRACT

The invention relates to a measuring device for measuring the temperature in a reactor container which can be crossflown by bulk material, in particular in a solid phase polycondensation, which takes place in an SSP-reactor. The aim of the invention is to protect the measuring device against mechanical stresses. Said aim is achieved by virtue of the fact that the measuring device, which is used to measure temperature, comprises at least one metal profile, at least one measuring tube and at least one sensor which is arranged therein. The metal profile can be connected to the walls of the reactor container and the measuring tube is connected to the metal profile such that it is partially reinforced on the external wall thereof by means of the metal profile. As a result, the measuring tube is soldered, screwed, riveted or rigidly connected in another manner to the metal profile. The metal profile is then secured to the inner wall of the reactor container. Another advantage thereof is that the weight, which is exerted on the column of the bulk material, is partially applied to the SSP reactors which are equipped with the measuring devices.

The invention relates to a sensor for measuring the temperature in a reactor vessel through which bulk material flows, in particular, during solid-phase polycondensation that takes place in an SSP reactor. Solid-phase polycondensation generally takes place in a so-called SSP reactor (solid state polymerizer), and usually here a temperature measurement is effected in the vessels through which the bulk material flows. In such cases, what is generally involved are continuous processes for increasing the viscosity of polymers, in particular, of polyester material and polyamides, in the solid phase, e.g. the polymers are present as granulate.

In principle, two methods for measuring temperature are known in this connection. In a first method, the temperature is measured with multiple welded-in measuring sleeves, so-called thermowells, in the outer wall of an SSP reactor. The second method consists in using a rod or a cable that is inserted from the top into an SSP reactor and has multiple measuring points along its vertical extent to determine the temperature at the corresponding points. In both methods, the respective temperatures are measured, for example, at ten measuring points in the cylindrical section of the SSP reactor that has a length of between 25 and 40 meters.

With both methods, the temperature can be measured in each case only at a consistently uniform distance from the reactor wall. This distance is determined by the length of the measuring sleeves or by the position of the flange in the case of multipoint measurement. The assumption is made that the temperature of the granulate varies over the cross-section of the SSP reactor, however, the actual temperature curve cannot be determined precisely using previously known measurement systems. This would, however, be very important in order to know, for example, the average temperature of the granulate. Only with a precise knowledge of the actual temperature and fill level is it possible to affect the viscosity of the product in a precise manner. Without this capability of knowing the average temperature, it is necessary to first wait for complete stabilization within a process in order to be able to effect a useful adjustment of the operating parameters. If this is not successful, in some cases it can result in products of abnormal viscosity, and thereby result in products is of lesser quality.

The applicable situation for welded-in measuring sleeves into which sensors are inserted is that the measuring sleeves are only of short length, and additionally must be supported from below. Otherwise the flowing granulate column would, due to its weight, deform them or even snap them off. The short length of the measuring sleeves results in the significant disadvantage that the actual measurement is affected by radiation losses through the unheated reactor wall. The problem becomes clear if one visualizes the transfer and conduction of heat in the region of the measurement. The hot granulate transfers its heat to the sleeve. At the same time, only a few granulate bodies contact the surface of the sleeve, and even then only at extremely small contact surfaces. The heat exchange is in any case very small. An additional factor is that PET (polyethylene terephthalate) is a poor heat conductor; in other words, in total only a very small quantity of heat is transferred to the sleeve. The sleeve itself consists of steel of several millimeters wall thickness and conducts the heat very well. As a result, the heat is, on the one hand, very readily transferred to the inserted sensor where the temperature is actually measured, and, on the other hand, however, also transferred out of the reactor where the heat is dissipated by cold ambient air. This “lost” quantity of heat results in the sleeve always having a lower temperature than the granulate. The measured value is thus distorted, and in fact to a much greater degree than with liquids in which significantly more heat can be transferred. During actual operation of the SSP reactor, this can is be observed from the fact that the measured temperature climbs immediately and clearly detectably as soon as the throughput of granulate is increased. This is because given a higher throughput, i.e. at a greater flow rate, the sleeves are contacted by more granulate per unit of time, and more heat energy is transferred to the sleeves. However, the realized heat losses remain the same, and the indicated temperatures rise without the actual product having in fact been heated.

A comparable problem does not occur with a rod probe or cable probe inserted into the reactor vessel from above and having multiple measuring points. Although heat is also conducted here along the probe, this nevertheless results only at the top-most measuring point in a detectable distortion of the indicated value. The measurement of temperatures which is virtually loss-free in terms of heat energy is reflected in measured values that are approximately 3 to 5° C. higher than comparable measurements with comparison sleeves. The fundamental disadvantage of cable probes, however, lies in the lower mechanical stability of the measurement chains. The flowing granulate column and the sharp edges of the granulate grains destroys the chains after only a short time. Another disadvantage consists in the fact that defective measuring units cannot be repaired or exchanged. Only the complete probe with all of the measuring units can be replaced; and this requires in each case the complete shutdown and emptying of the relevant SSP reactor. Rod probes have been employed for many years and have a considerably better mechanical stability than do cable probes. Their length is limited, however, since the rod must be transportable and manipulatable. Four up to a maximum of 5 meters have proven to be the upper limit for the length, whereas the reactors in which the rod probes end up being used are 25 to 40 meters high. The maximum life expectance for these kinds of probes is approximately two years.

Sensors for measuring temperature in a melted mass have been disclosed in DE 101 33 495 C1 and JP 6207 1621. DE 101 33 495 C1 has a hollow shaft that accepts an axially slidable plunger with a temperature sensor. This approach provides a pressure-tight, shielded and stable sensor that however would not be protected from the above-described abrasion effects caused by bulk material. U.S. Pat. No. 4,028,139 also describes sensors that measure temperature and that are mounted in carrier tubes. Since in this case the temperature measurement is effected in a fixed bed, the problem of abrasion does not occur and the system does not have any protective measures.

The goal of the invention is therefore to improve temperature measurement in vessels through which bulk material flows. In particular, the goal here is to protect the sensor for measuring temperature against mechanical stresses.

This goal is achieved according to the invention by a sensor as specified in claim 1 and an SSP reactor having a sensor according to the invention.

The sensor for measuring temperature in a reactor vessel through which bulk material flows comprises a metal profile, at least one measuring tube, and at least one sensor located therein for measuring temperature, the metal profiles being designed to be attachable to the walls of the reactor vessel, and the measuring tube being attached to one of the metal profiles such that the tube is partially reinforced at its outer wall by the metal profile. This means, for example, that the measuring tube is welded, screwed on, riveted, or by other means fixedly attached to the metal profile. The metal profile can be attached to the inner wall of the reactor vessel, for example by a weld.

In a preferred embodiment, the measuring tube is reinforced by the metal profile at the tube's outer wall on the side in the reactor vessel directed into the granulate flow, for example, in the manner of a reinforcement plate beveled on both sides and having a gabled cross-section. In an advantageous variant, this cross-section has a width of 10 to 50 millimeters.

In another advantageous embodiment, the two ends of the measuring tube are attachable to the walls of the reactor vessel.

An advantageous embodiment of the sensor allows the sensor in the measuring tube to be slid along the tube's longitudinal axis. If the two ends of the measuring tube are attachable here to the walls of the reactor vessel, the sensor can extend along a full diameter of the reactor vessel. In order to position the sensor, the interior of the measuring tube can be accessible through the outer wall of the reactor vessel, for example, via an opening in the outer wall. Remotely controllable positioning devices are also conceivable if openings in the outer wall need to be avoided. Instead of one slidable sensor, however, multiple sensors can also be positioned at various points within the measuring tube that are connected to the monitoring system.

In addition, a preferred embodiment also provides that the sensor can be fixed in at least one specific position along the longitudinal axis of the measuring tube.

This approach enables the temperature to be measured at various distances from the vessel wall, for example, in the vicinity of the vessel wall of the reactor or, on the other hand, in center of the reactor vessel. For commercial utilization, it has proven to be advantageous if the sensors can be fixed in the above-mentioned positions in order to obtain locally fixed measuring points. This could be implemented by a mechanical detent mechanism, for example, an engagement of the sensors in corresponding depressions in the inner wall of the measuring tube.

A sensor according to the invention can be installed in an SSP reactor for the processing of granulate, where the metal profile is fixedly attached to the walls of the reactor vessel. The sensors are preferably attached to the walls of the reactor vessel at different levels and at angles offset relative to each other. For commercial utilization, a uniform vertical spacing between the sensors is recommended, one preferably between 0.1 and 4.0 meters. In addition, the angular offset, that is, the orientation of the metal profile relative to the longitudinal axis of the reactor vessel can be uniform. With a uniform vertical spacing and uniform angular offset, and in the case of simple straight metal profiles, one would effectively obtain an arrangement analogous to a spiral staircase. The resulting advantage then is a large number of measuring points that do not completely omit any relatively large interconnected region of the reactor vessel.

The described sensor, along with an SSP reactor equipped therewith, is particularly well for measuring temperatures in a charge of granulate.

The measuring tube is usually a steel tube that is inserted through an SSP reactor perpendicularly relative to its longitudinal axis and welded on both sides to the reactor wall. The steel tubes are then fitted with a metal profile in such a way that they resist the expected weight load of the granulate column. The required support points for the sensors in the form of temperature measuring probes are attached within the steel tubes themselves at different penetration depths, which sensors are, for example, of the PT100 type. As a result, it is possible in a simple embodiment to measure at, for example, two penetration depths previously specified by design.

However, steel tubes are also employed without a support surface for the tips of the temperature sensors of PT100 type. Instead, a sensor is then used that measures the surface temperature at the inner wall of the measuring tube and can be slid over half the diameter relative to the vessel cross-section of the reactor. As a result, a precise recording of the temperature curve between the vessel wall of the reactor and center of the reactor can be affected. This type of embodiment functions primarily to obtain additional information. Commercial reactors are generally fabricated with the above-referenced simple measuring system that provides design-specified penetration depths for the temperature measuring probes.

Ten measuring tubes, for example, are installed along the longitudinal extent of a reactor, which tubes are arranged offset relative to each other respectively by 90°. Other angles are also conceivable. The measuring tubes preferably run through the longitudinal axis of the reactor vessel; however, they can just as well be installed outside the central longitudinal axis. In this case, one aspect that must be considered is that lateral forces can also act on a measuring tube as a result of the flowing granulate. And it is of course self-evident that the temperature in the center of the reactor vessel cannot be measured in this way.

Another advantage of the sensors according to the invention, as well as of the SSP reactors equipped therewith, consists in the partial removal of the force of the weight exerted by the granulate column. Specifically, in the lower region of the SSP reactor the granulate comes under enormous pressure. Although the weight of the entire granulate column does not act on the granulate located at the bottom, nevertheless it is possible for deformations of the lower granulate grains to occur. This problem is amplified as the system capacity, i.e. the reactor, becomes taller. The metal profiles provided as protection for this purpose contribute to a significant extent to capturing the static pressure that due to the high granulate column acts as a load on the lowest layers of granulate. For this purpose, provision can be made in an especially useful embodiment of the invention that the metal profiles have a rough surface and are of a steeply tapered design such that the greatest possible fraction of the pressure load is taken up by the friction of the flowing granulate on the surface of the metal profiles.

An embodiment according to the invention is described below using the example of the figures.

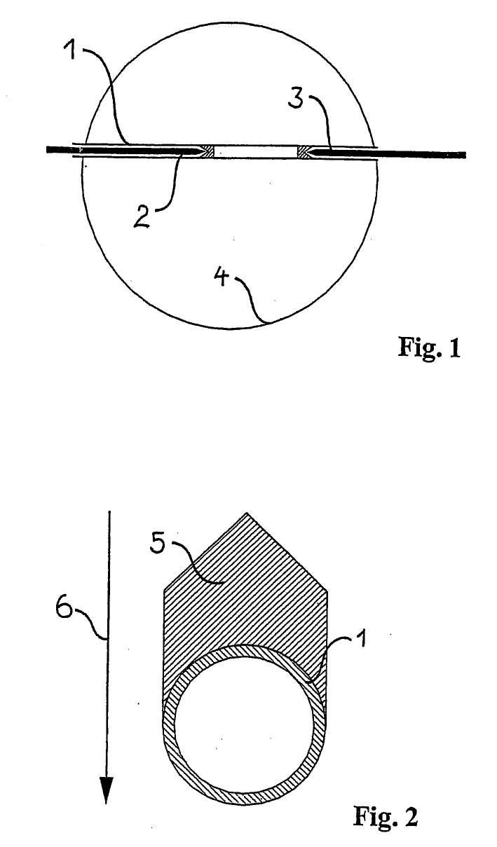

FIG. 1 shows a cross section through a cylindrical reactor vessel, specifically, at the level at which a measuring tube 1 is located. In the figure, the measuring tube 1 runs above the center of the circular cross-section and is welded at both ends to the wall 4 of the reactor vessel. This means that the measuring tube 1 does not run through the center axis of the reactor, and thus that the measuring points of the two sensors 2 and 3 are located outside the central longitudinal axis of the reactor vessel.

FIG. 2 shows a cross-section through a measuring tube 1 with a metal profile 5 that is designed as a reinforcement plate beveled on both sides over the entire length of measuring tube 1. As a result, part of the weight that is exerted by the granulate column in the flow direction of the granulate flow 6 is deflected.

Another embodiment that can be employed for reasons of stability in particular in SSP reactors of greater diameter, for example, more than 3.5 meters, is not designed as a straight sensor between two points of the reactor wall, but as a Y-shaped unit with three legs that are attachable at three points to the walls of the reactor vessel. Here the legs preferably form the same angle of and meet at the reactor center. While all three legs contain a metal profile 5, measuring tubes 1 can, depending on the measurement task, also be installed only on one or two of the legs.

### LIST OF REFERENCE NUMERALS

1 measuring tube
2 first sensor
3 second sensor
4 wall of the reactor vessel
5 metal profile
6 granulate flow direction

1. A sensor for measuring the temperature in a reactor vessel through which bulk material flows, comprising at least one metal profile, at least one measuring tube, and at least one sensor located in the measuring tube wherein the metal profiles are designed to be attachable to the walls of the reactor vessel, and the measuring tube is attached to one of the metal profiles such that the tube is partially reinforced at its outer wall by the metal profile.

2. The sensor according to claim 1 wherein the measuring tube is attached to the metal profile such that it is reinforced by the metal profile at its outer wall on the side facing the granulate flow in the reactor vessel.

3. The sensor according to claim 1 wherein the two ends of the measuring tube are attachable to the walls of the reactor vessel.

4. The sensor according to claim 1 wherein the one sensor is designed to be slidable within the measuring tube along the longitudinal axis of the measuring tube.

5. The sensor according to claim 1 wherein the sensor is designed to be fixable within the measuring tube in at least one predetermined position along the longitudinal axis of the measuring tube.

6. The sensor according to claim 1 wherein the metal profiles have a gable-like cross-section with a width of 10 to 50 millimeters.

7. A SSP reactor for processing granulate wherein the reactor is provided with a sensor according to of claim 1.

8. The SSP reactor according to claim 7 wherein the metal profiles are attachable at different levels to the walls of the reactor vessel.

9. The SSP reactor according to claims 7 wherein the vertical spacings between the metal profiles are uniform.

10. The SSP reactor according to claims 7 wherein the metal profiles are located at vertical spacings of 0.1 to 4.0 meters.

11. The SSP reactor according to one of claims 7 wherein the metal profiles are attachable to the walls of the reactor vessel offset at angles relative to each other.

12. The SSP reactor according to claim 11 wherein the angular offs.

13. In combination with an SSP reactor filled having a vertically extending side wall and through which a granulate is moved vertically, a temperature-measuring device comprising:
a horizontal heat-conductive tube inside the reactor and having opposite ends fixed to the side walls of the reactor, whereby the tube is heated by the granulate;
a shield profile fixed to the tube on a side thereof turned into a direction of flow of the granulate; and
at least one temperature sensor inside the tube.

14. The combination defined in claim 13 wherein the reactor side walls has holes aligned with the tube and giving access to an interior of the tube.

15. The combination defined in claim 13, further comprising
means for sliding the tube along the tube and for simultaneously recording a temperature of the tube in accordance with an instantaneous position of the sensor inside the tube.

16. The combination defined in claim 13 wherein there are a plurality of the sensors in the tube, spaced from one another.

17. The combination defined in claim 13 wherein the profile is gable-shaped and pointed into the flow direction.

18. The combination defined in claim 17 wherein the tube is cylindrical and has a diameter and the shield has a width equal generally to the tube diameter.

19. The combination defined in claim 13 wherein the tube and shield extend substantially through a longitudinal center axis of the reactor.

20. The combination defined in claim 19 wherein the tube is Y-shaped and has three arms that meet at the axis, one such sensor being provided in each of the arms, the shield profile being complementarily Y-shaped.
